(19) United States
(12) Patent Application Publication
(10) Pub. No.: US 2004/0131152 A1
(43) Pub. Date: Jul. 8, 2004

(54) Apparatus and method for determining a parameter of a sample

(75) Inventors: Simon Bates, West Lafayette, IN (US); Kevin Matney, Aurora, CO (US); David K. Bowen, Warwick (GB)

Correspondence Address: BURNS DOANE SWECKER & MATHIS L L P, POST OFFICE BOX 1404, ALEXANDRIA, VA, 22313-1404, US

(73) Assignee: Bede plc, Durham (GB)

(21) Appl. No.: 10/702,743

(22) Filed: Nov. 7, 2003

Related U.S. Application Data
(60) Provisional application No. 60/424,687, filed on Nov. 8, 2002.

(51) Int. Cl. G01N 23/20

(52) U.S. Cl. 378/70

(57) ABSTRACT

An apparatus and method for determining a parameter of a constituent of a sample employ a radiation source, focusing means for focusing emitted radiation at a first position on the sample, detecting means for detecting the radiation reflected from or transmitted through the sample and adapted to generate a signal representative of the detected radiation, processing means for receiving the signal and determining a parameter of a constituent of the sample corresponding to the signal, and translational repositioning means adapted to translate the focused radiation to a second position on the sample.

This application claims the benefit of U.S. Provisional Application No. 60/424,687 filed Nov. 8, 2002, the entire contents of which are incorporated herein by reference.

### BACKGROUND

The present invention relates to the determining of parameters of a sample. In particular, but not exclusively, the invention relates to X-ray diffraction applied to a tablet or pill.

During the preparation of medical drugs in tablet form, the active chemical ingredients undergo a number of processes. They are mixed with ingredients such as excipients and bonding agents, they may be coated, they may be heat treated and they are normally highly compressed. Such processing may result in the change of structure of critical components in the end product, which may cause a variation in the dispersion rate of the drug, in the consistency of its effects, or, in extreme cases, in a change in its physiological effects.

With the increase in size and complexity of drug molecules and with increasing regulatory control of drug manufacture, it is becoming very important to have a method of characterising such changes in typical samples of manufactured drugs.

X-ray diffraction provides a powerful tool for determining the molecular structure of a sample material, in particular the degree of crystallinity of the material. X-ray diffraction is widely used for analysing powders. A powder form of sample material offers a random orientation of the crystals so that an incoming monochromatic beam will be diffracted by at least some of the crystals.

In order to study the material of a tablet, the tablet is typically broken up, any coating removed and the tablet is then ground. However, grinding may alter properties of the tablet such as: a change in crystallinity; a change in crystal morphology; loss of co-crystallised solvent, for example water; or phase transition from a desired meta-stable form to an undesired stable form.

X-ray diffraction has not typically been used for whole tablets for a number of reasons. These reasons include that existing diffractometers often have a line focus of the beam, or a point focus having too large a diameter, or that the intensity is insufficient. Also, the positioning means of the diffractometers are only adapted for rotational repositioning of the sample. Furthermore, translational repositioning of the sample is not possible as the sample holder would interfere with the diffraction process.

A few diffractometers are adapted for translational repositioning between multiple samples but only for combinatorial diffraction. In these cases, dry samples are typically loaded in a well plate which is topped up with a solvent or reactant. The solvent is then boiled off and the well plate is mounted on the diffractometer. Translational repositioning has the purpose of bringing a different well into the beam. The data is used to analyse the effects of different conditions. Therefore, the translational repositioning means simply functions as a sample changer.

All combinatorial diffraction is performed in a reflection mode. This is because the well plate either scatters strongly (if the well plate is made from a plastics material) or absorbs all X-rays (if made from a ceramics material).

Existing diffractometers, whether or not for combinatorial diffraction, are typically operated in the reflection mode. It is well known that reflection measurements only probe the sample surface and the volume near the surface up to a depth of about 1 mm, even for the lightest materials. However, pharmaceutical tablets have a considerable thickness, in many cases between 5 to 8 mm and a diameter of up to 30 mm for effervescent tablets.

Tablets may be coated for a number of reasons such as to: make the tablet easier to swallow (smooth surface); slow down the dissolution of the tablet; mask the taste of the excipient and/or active ingredient; or chemically or mechanically protect the tablet. In such cases, reflection data will only characterise the coating and contain very little, if any, information about the bulk of the tablet.

For uncoated tablets, a tablet press compacts the material near the surface, but may leave the centre of the tablet unaffected. Analyses in a reflection mode will not detect this non-uniformity.

### SUMMARY OF THE INVENTION

It is desirable that X-ray diffraction be performed as a function of position across the tablet. It is further desirable that X-ray diffraction be performed in a transmission mode to determine properties through the volume of the sample. It is further desirable that X-ray diffraction be performed using a sample holder that does not interfere with the diffraction process.

According to a first aspect of the present invention, there is provided an apparatus for determining a parameter of a constituent of a sample, comprising:

a radiation source;

focusing means for focusing emitted radiation at a first position on the sample;

detecting means for detecting the radiation reflected from or transmitted through the sample and adapted to generate a signal representative of the detected radiation;

processing means for receiving the signal and determining a parameter of a constituent of the sample corresponding to the signal; and

translational repositioning means adapted to translate the focused radiation to a second position on the sample.

It is to be understood that the term “parameter” includes the presence, absence or variation with position of the constituent of the sample, or a property thereof.

Preferably the radiation comprises X-ray radiation. Preferably the apparatus comprises an X-ray diffractometer.

Preferably the apparatus operates in a transmission mode.

Preferably the sample is in tablet form.

Preferably a holder is provided for holding the sample. Preferably the holder comprises a mounting member having an aperture for receiving the sample. Preferably the sample is held in the aperture using a film which is transparent or translucent to X-rays, such as Kapton or Mylar film. Preferably the mounting member is annular. Alternatively, the mounting member may be L-shaped.

Preferably the translational repositioning means is adapted to reposition the holder relative to the emitted radiation. Alternatively, or in addition, the translational repositioning means may be adapted to cause the focusing means to focus the emitted radiation at the second position.

Preferably the translational repositioning means is adapted to translate the sample along at least two orthogonal axes. Preferably each of the orthogonal axes are normal to the axis of the emitted radiation. Preferably the apparatus includes rotational repositioning means adapted to rotate the sample about at least two orthogonal axes.

Preferably the apparatus includes a display or display means for displaying a representation of the parameter at each of the first and second positions. Preferably the representation comprises a map, which may be colour coded.

The parameter determined may be the amount of the constituent that is amorphous. The parameter determined may be the local concentration of the constituent. The parameter determined may be the particle size of the constituent. The parameter determined may be the amount of constituent that is present in a local region of the tablet. The parameter determined may be the polymorphic content of the constituent. The parameter determined may be the degree of hydration of the constituent. The parameter determined may be the local morphology of particles of the constituent. The parameter determined may be contamination of the tablet by foreign constituents.

According to a second aspect of the present invention, there is provided a method for determining a parameter of a constituent of a sample, comprising the steps of:

providing a radiation source;

focusing emitted radiation at a first position on the sample;

detecting the radiation reflected from or transmitted through the sample and generating a signal representative of the detected radiation;

processing the signal to determine a parameter of a constituent of the sample corresponding to the signal; and

translating the focused radiation to a second position on the sample.

According to another aspect of the invention, there is provided an apparatus for determining a parameter of a constituent of a sample, comprising:

a radiation source;

a focusing device that focuses incident radiation at a first position on a sample;

a detector that detects radiation reflected from or transmitted through the sample and that generates a signal representative of the detected radiation;

a processor that receives the signal and determines a parameter of a constituent of the sample corresponding to the signal; and

a translation stage that translates the sample relative to the focused radiation such that the focused radiation is directed to a second position on the sample.

### BRIEF DESCRIPTION OF THE FIGURES

An embodiment of the present invention will now be described, by way of example only, with reference to the accompanying drawings, in which:

FIG. 1 is a plan view of a tube of an X-ray generator;

FIG. 2 is a detailed view of a portion of the tube of FIG. 1;

FIG. 3 is a perspective view of a sample holder and translational repositioning means;

FIG. 4 is a diagrammatic plan view of the mapping of a tablet;

FIG. 5 is a diagrammatic side view of the mapping of a tablet;

FIG. 6 is a graph of the results of the tablet mapping showing intensity against diffraction angle;

FIG. 7 is a tablet map of a parameter of a constituent of the tablet; and

FIG. 8 is a tablet map of another parameter of a constituent of the tablet.

### DETAILED DESCRIPTION OF EXEMPLARY EMBODIMENTS

According to an aspect of the invention, X-ray diffraction is used for a number of types of analyses to provide information relating to tablets or pills. These include but are not limited to: quantitative analysis of the active ingredient, measured by the intensities of the crystalline peaks; and structural analysis, for example the ratio of crystalline to amorphous content, measured by the intensity of the background (diffuse) scattering between the peaks. It may also be possible to determine the particle size of the active ingredient or excipient, measured by the widths of the diffraction peaks.

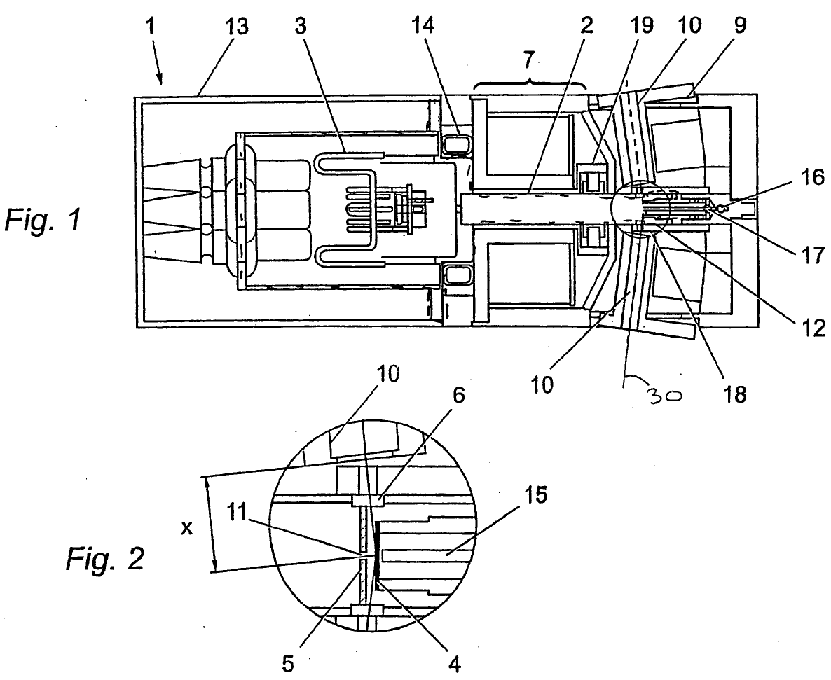

A suitable X-ray generator is required, and the Bede Microsource® (as disclosed in WO 98/13853) provides such a suitable generator. FIGS. 1 and 2 show the generator.

The X-ray generator 1 comprises: an evacuated and sealed X-ray tube 2; an electron gun 3; an X-ray target 4; an internal electron mask 5; and an X-ray window 6 consisting of a thin tube of material such as beryllium. This window also connects the tube 2 to the target assembly 12 containing the target 4.

The X-ray tube 2 is contained within a housing 13. The generator 1 also includes a system 7 for focusing and steering the electron beam onto the target, a cooling system 15,16,17 to cool the target material, kinematic mounts 9 to allow precise and repeatable mounting of X-ray devices for focusing the X-ray beam, and X-ray focusing devices 10 of varying configurations and methods. X-ray mirrors 10 are supplied in pre-aligned units so that re-alignment is not necessary after exchange.

The X-ray tube 2 produces a well focused beam of electrons impinging on a target material 4. The electron beam from the gun 3 is centred in the elongated portion of the X-ray tube 2 by a centring coil 14. The electron beam is focused to a spot of varying diameter. Focusing down to a diameter of less than 5 μm may be achieved by an axial lens 7 which may be either a quadrupole, multipole or solenoid type.

The target 4 is a metal, such as copper. The system encompasses an X-ray focusing device 10 located close to the source to provide a magnified image of the focal spot at controlled varying distances from the source. The distance x between the focusing mirror 10 and the source on the target 4 is small, preferably about 11 mm, to ensure close coupling.

The generator 1 of FIG. 1 is capable of producing a high intensity X-ray beam 30 having a focal spot of very small dimensions (a diameter in the range of 1 to 100 μm is possible) using a low operating power.

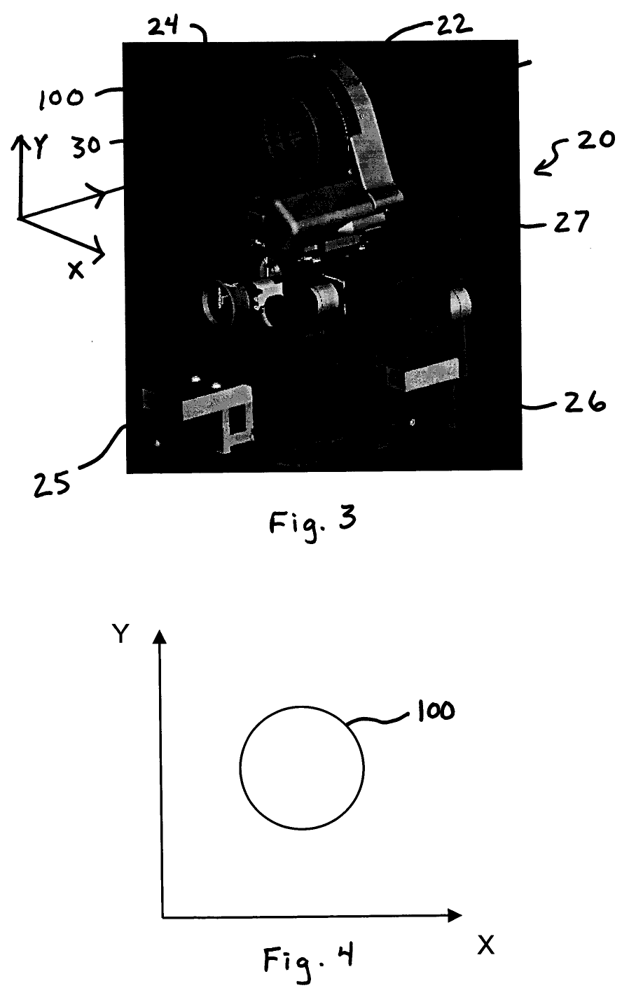

The generator 1 may be combined with a sample holder 20, shown in FIG. 3, which includes a translation stage or translational repositioning means. Using the small diameter focal spot of the beam 30 produced by the generator 1 in combination with the translational repositioning means, it is possible to make measurements of parameters as a function of position on a tablet 100. Such measurements may be referred to as “tablet mapping”. Measurements of a desired parameter or parameters of a tablet or other sample can be made as a function of position over a length scale of about 30 mm or less, or over an area of about 7 cm² or less. More particularly, such measurements can be advantageously made over a length scale of about 10 mm or less, or over an area of about 0.8 cm² or less.

The holder 20 comprises an annular mounting member 22 having an aperture 24 for receiving the tablet 100. The tablet 100 is held in place within the aperture 24 using Kapton or Mylar film. Therefore, for practical translations and rotations of the sample, the holder 20 does not interfere with the diffraction process.

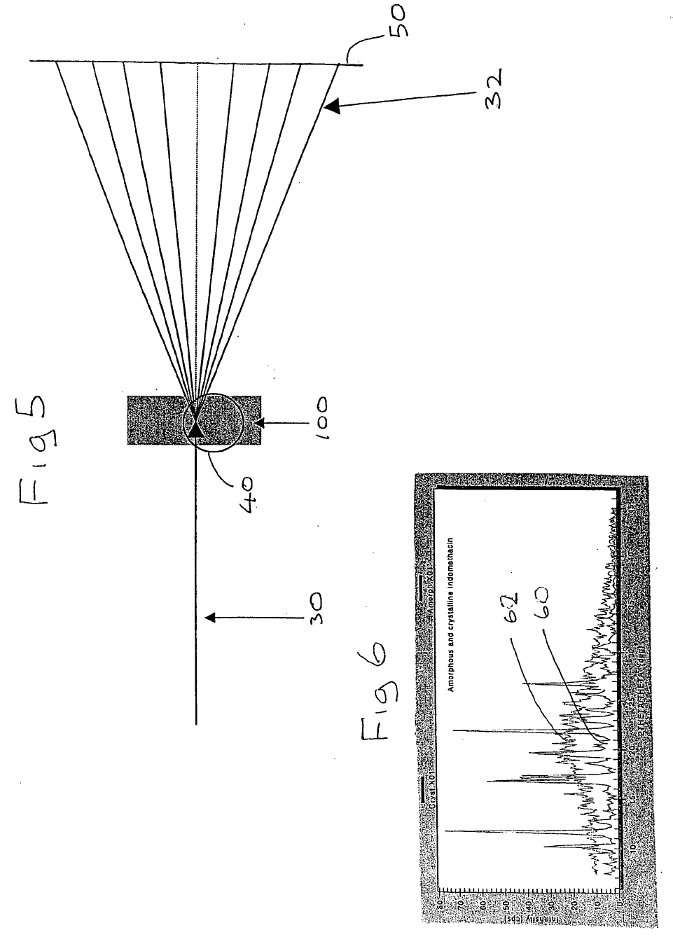

The translational repositioning means is adapted to reposition the holder 20 relative to the X-ray beam 30. The translational repositioning means comprises a first motor 25 which allows translation of the tablet 100 along the axis of the beam 30 and also a second motor 26 and third motor (not shown). The second and third motors allow translation along two orthogonal axes (termed the X and Y axes in FIGS. 3 and 4) which are normal to the axis of the beam 30.

The apparatus also includes a rotator or rotational repositioning means in the form of a fourth motor 27 and a fifth motor (not shown). The fourth motor 27 and fifth motor are adapted to rotate the tablet 100 about two orthogonal axes. These axes are the beam axis and the Y axis respectively.

Translation of the tablet 100 along the axes normal to the beam 30, together with rotation about the Y axis, provide the mapping of the tablet 100. Translation along the beam axis allows correction for the tablet thickness. Rapid sample rotation about the beam axis can be used to average the preferred orientation, while a controlled sample rotation about the same axis can be used to quantify crystallite orientation.

FIG. 5 shows operation of the apparatus at a first position 40 of the tablet 100. The set up allows operation in a transmission mode. The X-ray beam 30 is transmitted through the thickness of the tablet 100 and is diffracted such that the diffracted beam 32 leaves the tablet at various angles to the approaching beam axis. The diffracted beam 32 then impinges upon a detector or detecting means in the form of a screen 50. The screen 50 generates a signal representative of the detected radiation. The value of the signal is proportional to the intensity of the radiation sensed. Two typical signals 60, 62 with respect to the diffraction angle are shown in FIG. 6.

In FIG. 6 the first signal 60 relates to a crystalline material. The peaks of the signal therefore tend to be narrow and the background radiation is low. In contrast, the second signal 62 relates to a non-crystalline or amorphous material. There are therefore few peaks of any size and the background is high.

The apparatus includes a processor or processing means (not shown) for receiving the signal at each position and determining a parameter of a constituent of the tablet 100 corresponding to the signal. The translational repositioning means then repositions the tablet 100 and the process is repeated at a second position.

Once the signal has been processed for the second position the process is repeated at many subsequent positions until the entire tablet (or a significant number of discrete points to characterise the entire tablet) has been mapped.

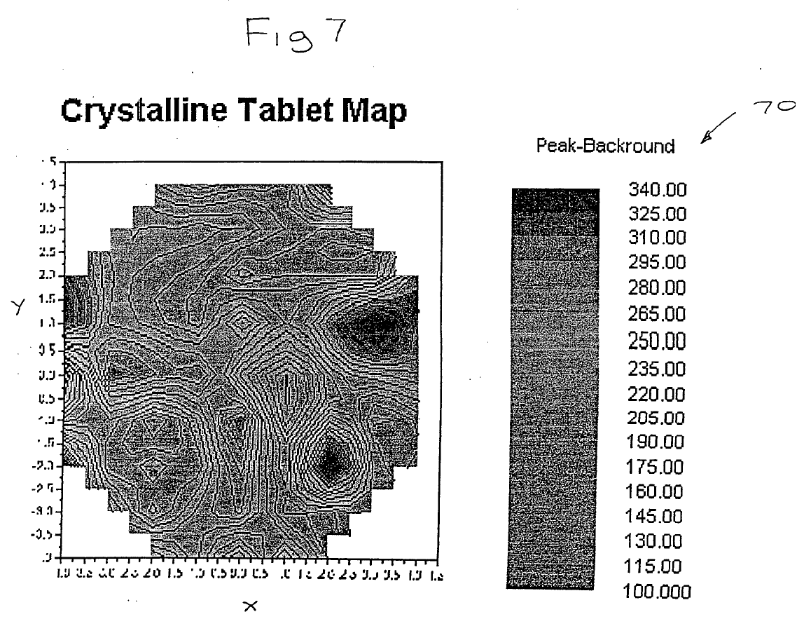

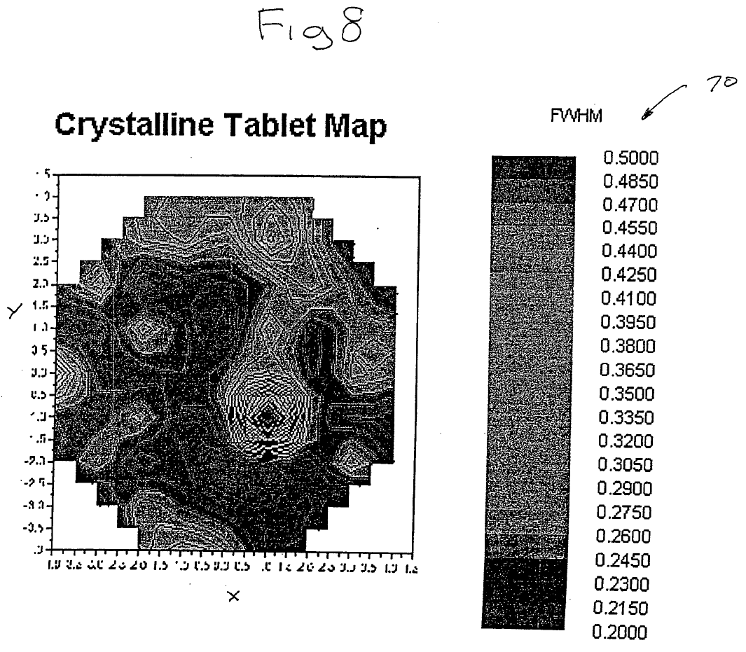

FIGS. 7 to 8 show tablet maps for a particular sample. The sample used is the drug indomethacin (IMC). IMC is a non-steroidal anti-inflammatory drug, and has been the subject of previous structural X-ray analysis but only in an ingredient form, not as a whole tablet.

Processing and filtering of the data is carried out. This may be using conventional spreadsheet software or dedicated plotting software, such as Bede3D™. The latter software offers a colour-coded representation of the parameter value as a function of position.

The amorphous content of a tablet 100 may be mapped by measuring the intensity of the background scattering as a function of position.

In FIG. 7, the local concentration was measured from the intensity of one of the crystal diffraction peaks that was identified as belonging to the IMC constituent. The background was subtracted (to eliminate the amorphous contribution) and the intensity plotted as a function of position. The tablet map shows this intensity, representing the concentration of the active ingredient, as a color-coded scale 70. There is a variation of a factor of approximately 3 in this concentration across the tablet. This will be directly related to physiological activity.

It may be possible to determine the particle size by measuring the width of a crystal diffraction peak, usually as the Full Width at Half-Maximum (FWHM). There is a known relationship between this width and the particle size, after extracting effects due to micro-stress. Alternatively, by using different reflections, the particle size and micro-stress may be separated. FWHM may also be used to measure amorphous content.

The FWHM is plotted in the tablet map of FIG. 8 by a color-coded value as a function of position. Particle size and stress both affect dispersion of the drug in the body, since dissolution is approximately proportional to the inverse square of the particle size, and highly-stressed crystals dissolve more readily. Variations in particle size may be introduced deliberately, in order to release the drug gradually over a period, or accidentally during the manufacturing process, in which case the time-dependent action of the drug will be uncontrolled. In this case there is a variation of a factor of about 3 in the FWHM, roughly form the centre to the edge of the tablet.

Any parameter that may be measured on a fine scale by X-ray, optical, infrared or other probes may be mapped and represented in this way. This includes, but is not limited to: polymorphic content; degree of hydration; particle morphology; and contaminant content.

Various modifications and improvements can be made without departing from the scope of the present invention as given in the appended claims. The scope of the invention is not limited to the preceding description. All variations and equivalents that fall within the range of the claims are intended to be embraced therein.

What is claimed is:

1. An apparatus for determining a parameter of a constituent of a sample, comprising:
a radiation source;
focusing means for focusing emitted radiation at a first position on the sample;
detecting means for detecting the radiation reflected from or transmitted through the sample and adapted to generate a signal representative of the detected radiation;
processing means for receiving the signal and determining a parameter of a constituent of the sample corresponding to the signal; and
translational repositioning means adapted to translate the focused radiation to a second position on the sample.

2. An apparatus as claimed in claim 1, wherein the radiation comprises X-ray radiation.

3. An apparatus as claimed in claim 2, wherein the apparatus comprises an X-ray diffractometer.

4. An apparatus as claimed in any preceding claim, wherein the apparatus operates in a transmission mode.

5. An apparatus as claimed in any preceding claim, wherein the sample is in tablet form.

6. An apparatus as claimed in any preceding claim, including a holder for holding the sample, and wherein the holder comprises an annular mounting member having an aperture for receiving the sample.

7. An apparatus as claimed in claim 6, wherein the sample is held in the aperture using a film which is transparent or translucent to X-rays.

8. An apparatus as claimed in claim 6 or 7, wherein the translational repositioning means is adapted to reposition the holder relative to the emitted radiation.

9. An apparatus as claimed in any preceding claim, wherein the translational repositioning means is adapted to translate the sample along at least two orthogonal axes.

10. An apparatus as claimed in claim 9, wherein each of the orthogonal axes are normal to the axis of the emitted radiation.

11. An apparatus as claimed in any preceding claim, including rotational repositioning means adapted to rotate the sample about at least two orthogonal axes.

12. An apparatus as claimed in any preceding claim, including display means for displaying a representation of the parameter at each of the first and second positions.

13. An apparatus as claimed in claim 12, wherein the representation comprises a map.

14. An apparatus as claimed in any preceding claim, wherein the translational repositioning means is further adapted to translate the focused radiation to a third position and a plurality of subsequent positions on the sample.

15. An apparatus as claimed in any preceding claim, wherein the parameter determined is the amount of the constituent that is amorphous.

16. An apparatus as claimed in any of claims 1 to 14, wherein the parameter determined is the local concentration of the constituent.

17. An apparatus as claimed in any of claims 1 to 14, wherein the parameter determined is the particle size of the constituent.

18. An apparatus as claimed in any of claims 1 to 14, wherein the parameter determined is the amount of constituent that is present in a local region of the tablet.

19. An apparatus as claimed in any of claims 1 to 14, wherein the parameter determined is the polymorphic content of the constituent.

20. An apparatus as claimed in any of claims 1 to 14, wherein the parameter determined is the degree of hydration of the constituent.

21. An apparatus as claimed in any of claims 1 to 14, wherein the parameter determined is the local morphology of particles of the constituent.

22. An apparatus as claimed in any of claims 1 to 14, wherein the parameter determined is contamination of the tablet by foreign constituents.

23. A method for determining a parameter of a constituent of a sample, comprising the steps of:
providing a radiation source;
focusing emitted radiation at a first position on the sample;
detecting the radiation reflected from or transmitted through the sample and generating a signal representative of the detected radiation;
processing the signal to determine a parameter of a constituent of the sample corresponding to the signal; and
translating the focused radiation to a second position on the sample.

24. A method as claimed in claim 23, wherein the radiation comprises X-ray radiation.

25. A method as claimed in claim 24, wherein the X-ray radiation is diffracted by the sample.

26. A method as claimed in any of claims 23 to 25, wherein the sample is in tablet form.

27. A method as claimed in any of claims 23 to 26, wherein the sample is translated along at least two orthogonal axes.

28. A method as claimed in claim 27, wherein each of the orthogonal axes are normal to the axis of the emitted radiation.

29. A method as claimed in any of claims 23 to 28, including the step of displaying a representation of the parameter at each of the first and second positions.

30. A method as claimed in any of claims 23 to 29, including the step of translating the focused radiation to a third position and a plurality of subsequent positions on the sample.

31. A method as claimed in any of claims 23 to 30, wherein the parameter determined is the amount of the constituent that is amorphous.

32. A method as claimed in any of claims 23 to 30, wherein the parameter determined is the local concentration of the constituent.

33. A method as claimed in any of claims 23 to 30, wherein the parameter determined is the particle size of the constituent.

34. A method as claimed in any of claims 23 to 30, wherein the parameter determined is the amount of constituent that is present in a local region of the tablet.

35. A method as claimed in any of claims 23 to 30, wherein the parameter determined is the polymorphic content of the constituent.

36. A method as claimed in any of claims 23 to 30, wherein the parameter determined is the degree of hydration of the constituent.

37. A method as claimed in any of claims 23 to 30, wherein the parameter determined is the local morphology of particles of the constituent.

38. A method as claimed in any of claims 23 to 30, wherein the parameter determined is contamination of the tablet by foreign constituents.

39. An apparatus for determining a parameter of a constituent of a sample, comprising:
a radiation source;
a focusing device that focuses incident radiation at a first position on a sample;
a detector that detects radiation reflected from or transmitted through the sample and that generates a signal representative of the detected radiation;
a processor that receives the signal and determines a parameter of a constituent of the sample corresponding to the signal; and
a translation stage that translates the sample relative to the focused radiation such that the focused radiation is directed to a second position on the sample.
